(19) United States
(12) Patent Application Publication
(10) Pub. No.: US 2013/0015108 A1
(43) Pub. Date: Jan. 17, 2013

(54) DEVICE FOR EXTRACTING CONTAINERS

(71) Applicants: Ulrich Krauss, Ilshofen (DE); Steffen Humpfer, Satteldorf (DE); Axel Woll, Stuttgart (DE); Tobias Mugele, Sillenbuch/Riedenberg (DE)

(72) Inventors: Ulrich Krauss, Ilshofen (DE); Steffen Humpfer, Satteldorf (DE); Axel Woll, Stuttgart (DE); Tobias Mugele, Sillenbuch/Riedenberg (DE)

(73) Assignee: ROBERT BOSCH GMBH, Stuttgart (DE)

(21) Appl. No.: 13/509,680

(22) PCT Filed: Oct. 1, 2010
(86) PCT No.: PCT/EP2010/064627

§ 371 Date: Oct. 2, 2012

(30) Foreign Application Priority Data
Nov. 12, 2009 (DE) 10 2009 046 662.2

(51) Int. Cl. B07C 5/00

(52) U.S. Cl. 209/523

(57) ABSTRACT

The invention relates to a device (10) for extracting containers, in particular pharmaceutical containers, from a first transport unit (15) conveying the containers in transport containers (1), having a first identification unit (32) arranged on the transport path of the first transport unit (15) for identification of the transport containers (1), having a discharge unit (24) downstream of the first identification unit (32) which transfers one transport container (1) to a second transport unit (23), on the conveying section of which a withdrawing unit (35) for withdrawing at least one container is arranged and having a feeding unit (27) for feeding the transport container (1) back to the first conveyance unit (15).

### BACKGROUND OF THE INVENTION

The invention relates to a device for extracting containers.

It is known in the pharmaceutical packaging industry, how to process containers like syringe bodies, vials or ampoules on combined filling and closing machines. In this case, the pharmaceutical containers are filled, for example, with a liquid pharmaceutical, weighed and subsequently closed with a closure element. Within the scope of the production process or the different processing steps, the containers are furthermore subjected to various checks in order to ensure a proper filling as well as a proper closing of the containers. Should errors have thereby occurred during the processing of the containers, it is necessary to discharge the containers at a suitable station.

The direct extraction of the containers from a conveyance device, which conveys said containers, is known from prior art. That means that the gaps which thereby arise during the extraction of the containers either have to be filled with “good-receptacles” in order that problems are not created at the corresponding stations during subsequent processing steps or that the conveyance unit has to be stopped during the time that the containers are being checked or extracted from said conveyance unit. This is then especially problematic if the checking of the containers or the discharging of said containers from the conveyance unit takes a relatively long time.

A handling device is furthermore known from the German patent publication DE 196 04 100 A1, with which particularly syringe bodies can be individually or collectively extracted from a receptacle, which has receivers for the syringe bodies.

### SUMMARY OF THE INVENTION

Based on the technical field described above, the aim underlying the invention is to design a device for extracting containers in such a way that an ongoing production or conveyance process on a packaging line is interrupted as little as possible. This aim is met with a device for extracting containers according to the invention. The invention is thereby based on the idea that transport containers, which potentially contain defective containers, are transferred to a second transport unit, which is discrete, respectively separate, from a first transport unit. This makes it possible for the production or transport flow of transport containers not to be interrupted, i.e. subsequent transport containers comprising “good-receptacles” continue to be transported without the transport containers in question being discharged or stopped.

By virtue of the fact that the transport container comprising the potentially defective containers is situated on the second transport unit, the checking of the containers in the transport container on the second transport unit can last any desired length of time without the occurrence of any disadvantages. Especially relatively complex or time intensive tests can thus be carried out on the containers.

Provision is made in a preferred embodiment of the invention for the transport container to have a receiving unit for a plurality of containers disposed in receivers and for the receiving unit to be arranged to be able to be introduced in the transport container and to be withdrawn from the same. In so doing, the containers disposed in the receivers of the receiving unit can be withdrawn in a simple manner by means of a suitable withdrawing unit and replaced, for example, by “good-receptacles” so that the transport container can, for example, subsequently be fed directly back into the production flow, that is to say into the first transport unit.

In this case, it is particularly preferred for a unit for extracting and transporting the receiving unit out of the transport container to be disposed in the region of the second transport unit, said first-mentioned unit feeding the receiving unit to the withdrawing unit in order to withdraw at least one container from the transport container. As a result, a high degree of flexibility with regard to the disposal of the withdrawing unit is achieved, so that the extraction of containers is spatially separated from the extraction of the receiving units.

In order to ensure that the correct containers are withdrawn from the transport containers, provision is furthermore made in a further preferred embodiment of the invention for a second identification unit to be disposed in the region of the second transport unit and for said second identification unit to interact with the withdrawing unit to withdraw at least one container from the transport container. It is thereby ensured that only containers, which have been identified as defective by the first and the second identification unit, are withdrawn from the transport container.

The invention furthermore provides in an advantageous manner for a discharge unit for transport containers to be disposed in the region of the second transport unit. This discharge unit serves the purpose of discharging transport containers, which are either directly discharged by the first conveyance unit or themselves are still identified to be defective after being circulated via the second conveyance unit.

The invention can particularly provide for a testing device, in particular a weighing device, to be disposed in the region of the second transport unit. The containers, which have been identified as critical or defective or have been specifically or randomly selected by the operator or the machine controller, can be checked by means of suitable testing devices. As a result, the production stages of the packaging line can be checked or it can ensured that no containers are discharged, which are “good”.

A simple handling of the transport containers on the first transport unit and the second transport unit is facilitated if both transport units are configured in each case as conveyor belts, on which the transport containers are conveyed by frictional engagement. Such transport units are known in a variety of forms in assembly and manufacturing technology and facilitate the control of the movement of the transport containers, for example, through the use of conveyor belts, which extend transversely, as well as deflection or blocking elements which project into the conveyance path of said transport containers.

In order to document the result of the check or the number of non-defective containers in the transport container or to be able to summon up other items of information, provision is made in an advantageous modification to the invention for an identification unit for the transport containers, which are transported in this region, to be disposed in the region of the first transport unit.

The inventive device for extracting containers is preferably a component of a packaging line, which has a plurality of processing stations. In this case, the inventive device is preferably attached to the end of the packaging line. That means that all irregularities, respectively defects, detected on the containers during the production process of said containers are taken into account by the corresponding containers being discharged from the packaging line. To accomplish this end, provision is made in a preferred embodiment for the first identification unit of the device to be coupled with a control unit of the packaging line. By virtue of the fact that all errors, respectively data, that have occurred during the production process of the individual containers can be stored in the control unit of the packaging line, such a combination of features can ensure that all potentially defective containers are discharged using the device according to the invention.

### BRIEF DESCRIPTION OF THE DRAWINGS

Further advantages and features of the invention become evident in the following description of preferred exemplary embodiments as well as with the aid of the drawings, in which:

FIG. 1 shows a perspective view of a transport container together with pharmaceutical containers disposed in a receiving unit in the transport container,

FIG. 2 shows likewise a perspective view of the receiving unit with the pharmaceutical containers pursuant to FIG. 1,

FIG. 3 shows a top view of a device according to the invention for extracting containers and

FIG. 4 shows a perspective depiction of the device pursuant to FIG. 3.

### DETAILED DESCRIPTION

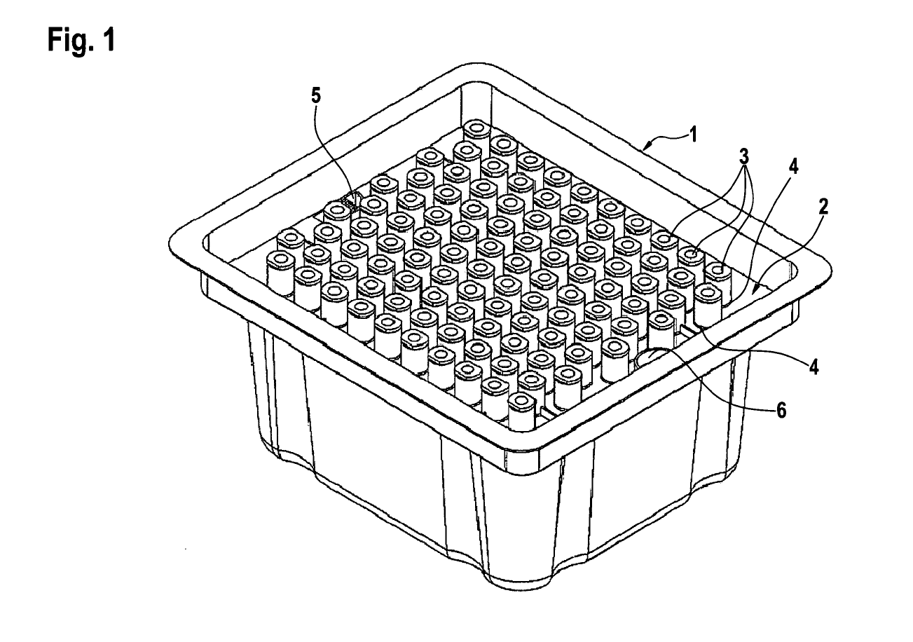

A transport container 1, which is also denoted as “tub” in the pharmaceutical industry, is depicted in FIG. 1. The crate-like transport container 1 serves to accommodate a receiving unit 2, which is also referred to as a “nest”. A plurality of pharmaceutical containers, in particular syringe bodies 3, can be disposed and transported in the receiving unit 2. Corresponding receivers 4 are configured in said receiving unit 2, which serve to accommodate the syringe bodies 3 in a positive-locking manner. Recesses 5, 6, which are designed to interact with a withdrawing unit (which will be explained later in detail) are furthermore evident on two opposing end faces of said receiving unit 2; thus enabling said receiving unit 2 to be extracted, i.e. lifted and lowered, out of the transport container 1.

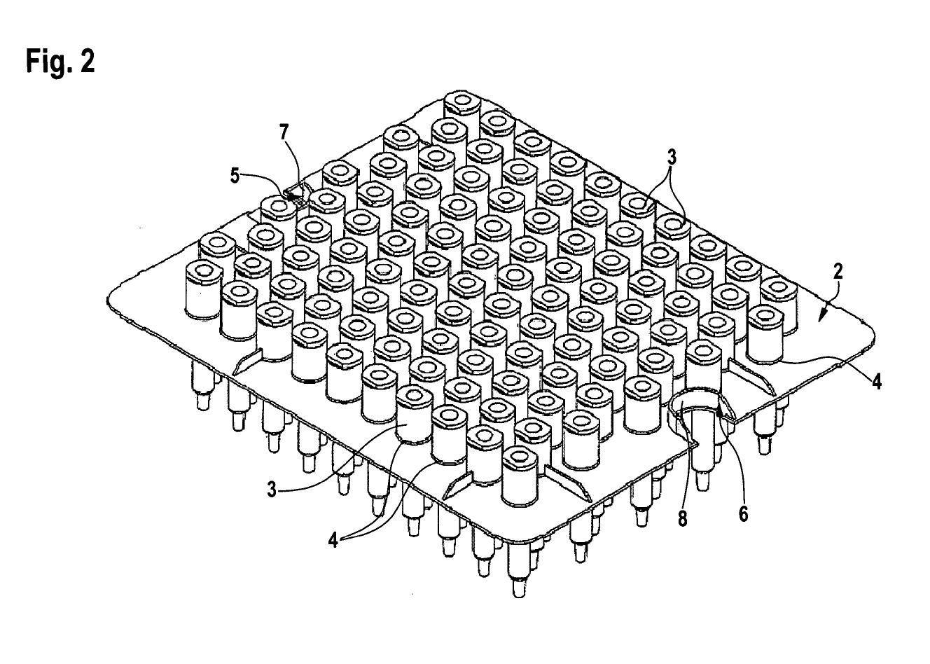

The receiving unit 2 including the syringe bodies 3 is again separately depicted in FIG. 2. In this instance, the recesses 5, 6, which are especially configured in the form of cutouts 7, 8, are evident. It can, furthermore, be seen that said syringe bodies 3 interact in the center region thereof with the receivers 4 of said receiving unit 2 in a positive-locking manner. Said syringe bodies 3 are disposed in said receiving unit 2 in a plurality of rows, wherein the individual rows are offset from one another and wherein said syringe bodies 3 within each row are in each case disposed at an equal distance to one another.

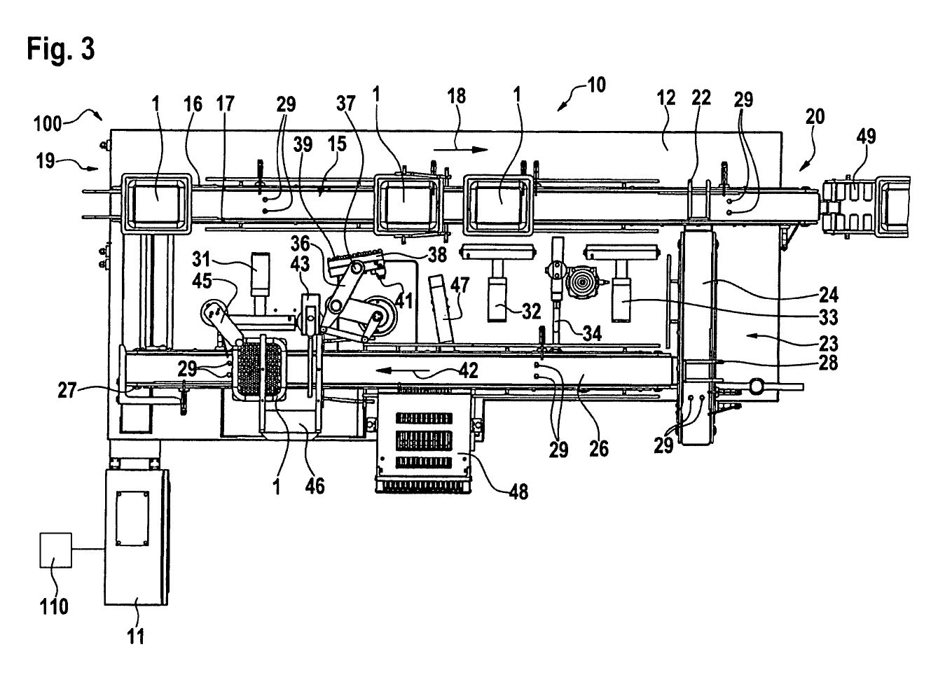

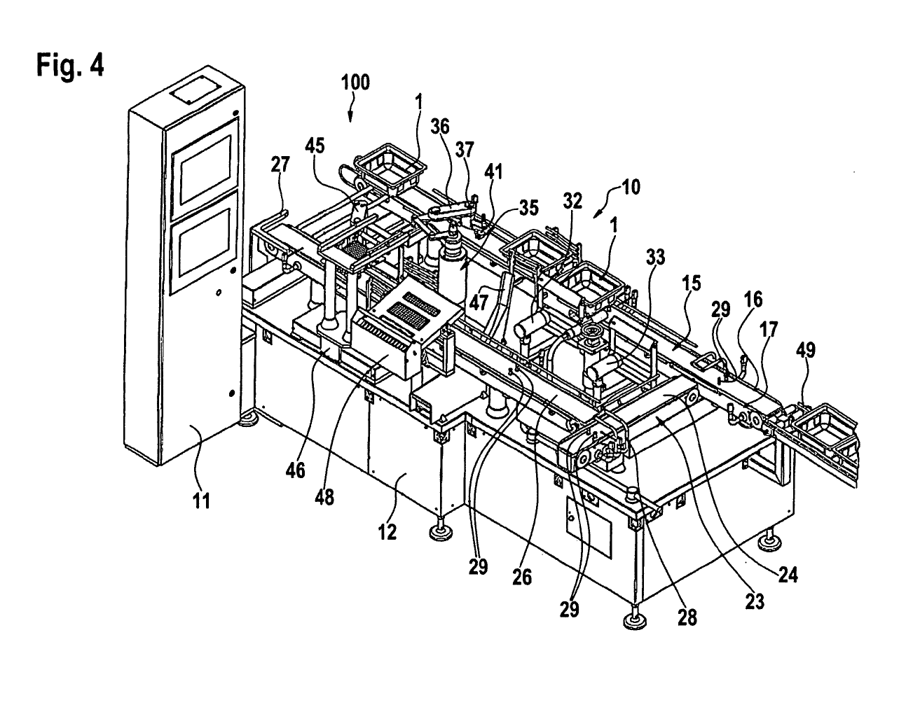

A device 10 according to the invention for extracting syringe bodies 3 is depicted in FIGS. 3 and 4. The device 10 is particularly in this case a component of a packaging line 100, which is incidentally not shown in detail and which comprises a plurality of processing stations, which likewise are not depicted. The syringe bodies 3 are subjected to a number of processing or treatment steps at these processing stations, said steps serving to fill and seal said syringe bodies 3. Said syringe bodies 3 are thereby filled in particular with a liquid pharmaceutical, which in each case must be dosed as accurately as possible. Moreover, it is very important for said syringe bodies 3 to be carefully sealed in order to prevent the ingress of germs or the like into the filled syringe bodies 3.

In order to sort out syringe bodies 3, which during the course of the production steps within the packaging line 100 were, for example, either not filled with a proper amount of filling material or whose sealing plugs or the like were, for example, not properly placed on the syringe bodies 3, the device 10 attaches in particular to the end of the actual packaging line 100. Said device 10 can, however, also explicitly serve the purpose of withdrawing syringe bodies 3 only for control purposes, even if said bodies were not previously classified as potentially defective. For the sake of simplicity, the following description will deal with potentially defective syringe bodies 3.

The packaging line 100 comprises a control unit 110, which acquires and stores all potential defects which have occurred to individual syringe bodies 3 during the production process. The control unit 110 of said packaging line 100 is in this case connected to a control unit 11 of the device 10. Particularly data concerning potentially defective syringe bodies 3 are transmitted to the control unit 11 of said device 10 by said control unit 110 of said packaging line 100.

The device 10 comprises a frame or a table top 12. A first conveyance or transport unit 15, which has by way of example two conveyor belts 16 and 17 that are arranged parallel and in spaced relation to one another, extends along a longitudinal side of the table top 12. In particular, the transport containers 1 are continuously conveyed by means of frictional contact on said conveyor belts 16 and 17. The conveyance direction of said transport containers 1 between an inlet region 19 of the device 10 and an outlet region 20 of said device 10 is denoted with the arrow 18 (FIG. 3).

The first transport unit 15 interacts with a second transport unit 23 via a first transfer unit 22. The second transport unit 23 comprises a discharge belt 24, which is transversely disposed with respect to said first transport unit 15 at the end of the table top 12 in the vicinity of the outlet region 20. A further transport belt 26, which is likewise a component of said second transport unit 23, is disposed parallel to said first transport unit 15. The transport belt 26 extends practically over the entire length of the device 10 and has a transfer unit 27, which in turn is disposed at a right angle to said transport belt 26.

In addition, it is essential for a second transfer unit 28 to be disposed in alignment with the transport belt 26 in the region of the discharge belt 24.

A plurality of locking elements, which can be moved up and down and serve to stop the movement of a transport container 1 on the transport units 15 and 23, is disposed in the region of the first transport unit 15 and the second transport unit 23. The transport units 15 and 23 thus far denoted and described are already universally known from conveyance technology so that the exact operation thereof will not be discussed in more detail at this point. Three cameras 31 to 33 are disposed by way of example on the table top 12 between said first transport unit 15 and the transport belt 26. In this case, each of the cameras 31 to 33 serves to acquire a code or a label (not depicted), which, for example, is arranged on a side wall of the transport container 1, and to compare said code or label with items of information deposited within the control unit 11 of the device 10.

In this case, the first camera 32 is provided to identify transport containers 1 transported on the first transport unit 15, whereas the second camera 33 serves to check the overprint on the transport container 1 made by means of a press button 34. Transport containers 1 situated on the transport belt 26 are identified by the camera 31. The press button 34 is furthermore disposed between the two cameras 32 and 33 in the region of the transport belt 15. With the aid of said press button, items of information, which are acquired using the cameras 31 to 33, are used to update said overprint or new information is applied to said transport container, for example, by means of a print image.

A handling robot 35 is disposed approximately in the central region of the table top 12, said robot having a multi-purpose tool 38, which is pivotable about a vertical axis 37, on one end of an arm 36. The multi-purpose tool 38 has in this case a block or oblong shape, wherein a plurality of gripping units 39 is disposed on one side of said multi-purpose tool 38, while an individual gripping tool 41 is disposed on an end region of the side of said multi-purpose tool 38 opposed to the gripping units 39. Whereas a complete row of syringe bodies 3 or a subset thereof can be extracted from the receiving unit 2, the gripping tool 41 serves the purpose of extracting an individual syringe body 3 out of the receiving unit 2.

A lifting unit 43 for lifting a complete row of syringe bodies out of the receiving unit 2 is attached to the handling robot 35 in the conveyance direction of the transport containers 1 on the transport belt 26 designated with arrow 42 in FIG. 3. A lifting-out means 45 having a transport frame 46 is attached to the lifting unit 43 likewise as viewed in the conveyance direction. Using the lifting out means 45, a complete receiving unit 2 can be withdrawn from the transport container 1 and set down onto the transport frame 46. Said transport frame 46 in turn carries the individual receiving unit 2 into the region of the lifting unit 43.

A reject receptacle 47 can further be seen on the table top 12 for syringe bodies 3 recognized to be defective as well as a unit 48, which enables complete rows of syringe bodies 3 to be extracted for manually reweighing a syringe body 3 or a container row. Although not depicted, provision can be optimally made for testing devices, in particular for weighing devices, to be disposed in the region of the handling robot 35 in order to check individual syringe bodies 3 or a plurality thereof with regard to the correct filling quantity.

The device 10 described to this point operates as follows: data with regard to potentially defective syringe bodies 3 is transmitted from the control unit 110 of the packaging line 100 to the control unit 11 of said device 10. Data or a picture of the identification feature imprinted on the transport container 1 are particularly transmitted. Which transport container 1 and which syringe bodies 3 disposed in the transport container are potentially defective ensue from said identification feature. The transport containers 1 conveyed in equal or unequal distances on the first transport unit 15 initially travel into the pick-up area of the first camera 32, where said transport containers are prevented from further conveyance by locking elements 29. The identification of the transport container 1 is performed with the camera 32 and is compared with the picture deposited in the control unit 11 or with the items of information deposited there. Should it thereby become evident that the transport container 1 in question does not contain any potentially defective syringe bodies, said transport container 1 subsequently travels immediately to the press button 34 in order for items of information to be optionally applied to said transport container 1. If the overprint is subsequently confirmed to be readable by the camera 33, the transport container is not pushed onto the discharge belt 24 by the first transfer unit 22. On the contrary, the locking elements 29 allow said transport container 1 to pass, for example, on a roller conveyor.

Should the transport container 1 relate on the other hand to a transport container 1 which contains potentially defective syringe bodies 3 or to a transport container which is to be subjected to a test or to one which cannot be identified or the identification overprint thereon is not correct, the transport container 1 in question is then transferred from the first transport unit 15 to the discharge belt 24. If said transport container 1 were identified (and if potentially defective syringe bodies 3 are to be extracted therefrom or a test thereof is to be carried out), said transport container 1 is then transferred to the transport belt 26 by the second transfer unit 28 at the discharge belt 24. Otherwise the locking elements 29 allow the relevant transport container 1 to pass through so that it is completely discharged. The transport container 1 in question then travels on the transport belt 26 to a renewed identification by camera 31. The corresponding transport container 1 is once again identified there in order to ensure that said container relates to that transport container 1, which was already identified with the camera 32 to be a transport container 1 containing potentially defective syringe bodies 3. The receiving unit 2 is moved onto the transport frame 46 using the lifting-out means 45. Said transport frame 46 coveys the extracted receiving unit 2 into the region of the lifting unit 43, where the corresponding row of syringe bodies 3 is lifted out of said receiving unit 2 in order to subsequently extract the potentially defective syringe body or bodies 3 using the handling robot 35, respectively the multi-purpose tool 38. The option now exists for the potentially defective syringe body or bodies 3 to be tested on a test device, which is not depicted, and for the syringe body or bodies 3 in question to be transferred into the separation container 47 if a defect is ascertained. Should this event take place, it is then also conceivable or possible for “good” syringe bodies 3 stored within the device 10 to be transferred into the corresponding receivers 5 of the receiving unit 2 so that said receiving unit 2 is completely filled with syringe bodies 3 potentially free from defects.

The receiving unit 2 treated in this fashion can subsequently be inserted back into the transport container 1 using the transport frame 46 and the lifting unit 45, whereupon the transport container 1 in question is then transferred back into the production flow, i.e. into a gap on the first transport device 15, with the aid of the transfer unit 27.

It is still essential that those transport containers 1, which have not been identified even after multiple cycles in the device 10 and on which tests have failed or the overprint of the press button 34 is not readable, be discharged at only one location, namely via the discharge belt 24.

The device 10 described to this point can be modified or varied in a variety of ways. Said device 10 is thus not limited to the use of the transport units 15 and 23 described but can also comprise transport units configured otherwise. It is merely essential that an alternate route in the manner of a bypass be created in addition to the main conveyance route for the transport containers 1. This bypass is set up for the purpose of checking and discharging potentially defective syringe bodies 3 or those which are to be subjected to a test; and in so doing, containers other than syringe bodies 3 can, of course, also be processed. By means of a modified disposal of the cameras 31 to 33 or other suitable identification devices, it is possible for the transport containers 1 to be identified independently from the location of an identification feature. It is likewise conceivable to dispose the press button 34 in such a way that a ram pressure on each side of the transport container 1 is possible.

1. A device (10) for extracting first containers (3), from a first transport unit (15) conveying the first containers (3) in transport containers (1), having a first identification unit (32) arranged on a transport path of the first transport unit (15) for identification of the transport containers (1), having a discharge unit (24) downstream of the first identification unit (32) which transfers one transport container (1) to a second transport unit (23), on the conveying section of which a withdrawing unit (35) for withdrawing at least one first container (3) is arranged and having a feeding unit (27) for feeding the transport container (1) back to the first transport unit (15).

2. The device according to claim 1, characterized in that the transport container (1) comprises a receiving unit (2) for a plurality of first containers (3) disposed in receivers (4) and in that the receiving unit (2) is arranged to be able to be introduced in the transport container (1) and to be withdrawn from the same.

3. The device according to claim 2, characterized in that an extracting unit (45, 46) for extracting and transporting the receiving unit (2) from the transport container (1) is disposed in a region of the second transport unit (23), said extracting unit (45, 46) feeding said receiving unit (2) to the withdrawing unit (43) for withdrawing at least one first container (3) from the transport container (1).

4. The device according to claim 1, characterized in that a second identification unit (31) is arranged in a region of the second transport unit (23) and in that the second identification unit (31) interacts with the withdrawing unit (35) for withdrawing at least one first container (3).

5. The device according to claim 1, characterized in that a discharge unit (28) for transport containers (1) is disposed in a region of the second transport unit (23).

6. The device according to claim 1, characterized in that a testing device is disposed in a region of the second transport unit (23).

7. The device according to claim 1, characterized in that the first and the second transport units (15, 23) are in each case configured as transport belts.

8. The device according to claim 1, characterized in that the device (10) has only a single discharge unit (49) for transport containers (1) or first containers (3) which are free from defects.

9. The device according to claim 1, characterized in that a marking unit (34) for the transport containers (1) transported in a region of the first transport unit (15) is disposed in the region of the first transport unit (15).

10. A packaging line (100) comprising a device (10) according to claim 1, characterized in that the first identification unit of the device (10) is coupled at least indirectly with a control unit (110) of the packaging line (100).

11. The packaging line according to claim 10, characterized in that the transport container (1) comprises a receiving unit (2) for a plurality of first containers (3) disposed in receivers (4) and in that the receiving unit (2) is arranged to be able to be introduced in the transport container (1) and to be withdrawn from the same.

12. The packaging line according to claim 11, characterized in that an extracting unit (45, 46) for extracting and transporting the receiving unit (2) from the transport container (1) is disposed in a region of the second transport unit (23), said extracting unit (45, 46) feeding said receiving unit (2) to the withdrawing unit (43) for withdrawing at least one first container (3) from the transport container (1).

13. The packaging line according to claim 10, characterized in that a second identification unit (31) is arranged in a region of the second transport unit (23) and in that the second identification unit (31) interacts with the withdrawing unit (35) for withdrawing at least one first container (3).

14. The packaging line according to claim 10, characterized in that a discharge unit (28) for transport containers (1) is disposed in a region of the second transport unit (23).

15. The packaging line according to claim 10, characterized in that a testing device is disposed in a region of the second transport unit (23).

16. The packaging line according to claim 10, characterized in that the first and the second transport units (15, 23) are in each case configured as transport belts.

17. The packaging line according to claim 10, characterized in that the device (10) has only a single discharge unit (49) for transport containers (1) or first containers (3) which are free from defects.

18. The packaging line according to claim 10, characterized in that a marking unit (34) for the transport containers (1) transported in a region of the first transport unit (15) is disposed in the region of the first transport unit (15).
